(19) United States
(12) Patent Application Publication
(10) Pub. No.: US 2003/0078019 A1
(43) Pub. Date: Apr. 24, 2003

(54) Method of brokering wireless services

(75) Inventors: Jheroen Pieter Dorenbsoch, Paradise, TX (US); Vijaykumar M. Patel, Fairfax, VA (US)

Correspondence Address: LAW OFFICES OF DAVID G. POSZ, 2000 L STREET, N.W., SUITE 200, WASHINGTON, DC, 20036, US

(73) Assignee: MOTOROLA, INC.

(21) Appl. No.: 10/000,863

(22) Filed: Oct. 24, 2001

(51) Int. Cl. H04B 1/18

(52) U.S. Cl. 455/154.1; 455/403

(57) ABSTRACT

A method according to the present invention provides a wireless system service reseller (22) with the capability of connecting a subscriber station (14) to a service provider system (16, 24) that offers the most advantageous service to the subscriber station (14) out of all service provider system choices. Initially, the service reseller (22) receives a service request from the subscriber station (14). It then evaluates available service provider systems (16, 24) to determine a most advantageous service provider system for the subscriber station (14) based on the received service request. After it evaluates the available service provider systems (16, 24), it instructs the subscriber station (14) to initiate communication using the most advantageous service provider system as determined based on its evaluation of available service provider systems (16, 24).

### FIELD OF THE INVENTION

The present invention relates generally to wireless network systems, and more particularly to a method in which a service reseller can direct a subscriber station such as a cellular phone to a service provider system according to changing service requirements at the subscriber station.

### BACKGROUND OF THE INVENTION

Methods of brokering or arranging for long distance service currently exist that enable a service reseller (SR) to have a dynamic relationship with service provider systems (SPs) over the publicly switched telephone network (PSTN). Specifically, if the SP is registered with the SR, the SR is capable of selling the services offered by a specific SP to a subscriber station (referred to hereafter interchangeably as subscriber, mobile or portable station (MS)) such as a mobile or portable cellular phone when the mobile station enters a zone of coverage and registers with the SR.

However, while the SR's relationship with registered SPs is dynamic from a coverage zone standpoint, the relationship is static from a services standpoint. Currently, a subscriber station is typically programmed with the frequencies on which it will look for an SP. The subscriber station may also be programmed with a finite list of the SPs to which it has subscribed for usage and a finite list of zones where it can operate. An SP will broadcast its SP identification and possibly zone identification on one of these frequencies. When the subscriber station looks for an SP on the programmed frequencies and detects such SP and zone identifications, it will compare the received identifications against the identifications in its list to determine if it can operate using the particular SP in the particular zone. Typically, it will then perform a wireless registration procedure with the SP.

The infrastructure of the SPs includes databases, such as Home Location Registers (HLRs), that contain information on each subscriber station. In particular, such databases contain information on the services that the subscriber station is authorized to use. The databases also contain information on agreements between SPs to allow one or more subscriber stations of one SP to operate in the system of the other SP. Similar information is stored in agreements between SRs and SPs to allow one or more subscriber stations associated with a specific SR to operate in the system of a specific SP. During the registration procedure, the information in one or more of these databases is used to determine whether the system will allow the subscriber station to operate using this SP in this zone. If so, the registration will be allowed; if not, the registration will be refused, and the subscriber station will search for other identifiers on other frequencies.

The information in the lists in the subscriber station and in the databases is static, and thus it may not cater to the actual needs of the subscriber station. As a result, a subscriber station must obtain required services from the SP system it first selects when it registers in a new zone, even if other SPs offering services more germane to the instantaneous service requirements of the subscriber station are available but not accessible by the SR. Such a condition makes it difficult for the SR to optimize its business because it cannot precisely control the SP selection of the subscriber station. Consequently, the subscriber station may select an SP that provides services to the MS at a cost to the SR that is higher than the cost of the same services provided by another SP.

### SUMMARY OF THE INVENTION

Accordingly, the present invention provides a method for providing a wireless system service reseller with the capability of connecting a subscriber station to a service provider system that offers the most advantageous service to the subscriber station out of all service provider system choices. Initially, the service reseller receives a service request from the subscriber station. It then evaluates all available but not necessarily accessible service provider systems to determine a most advantageous service provider system for the subscriber station based on the received service request. After it evaluates the available service provider systems, it requests initiation of services at the most advantageous service provider system if the service provider system is not currently accessible and instructs the subscriber station to initiate communication using the most advantageous service provider system as determined based on its evaluation of available service provider systems.

The methodology of the present invention therefore enables a service reseller to have a dynamic relationship with multiple service provider systems and to provide a subscriber, mobile, or portable station with services tailored to the station's instantaneous requirements, even if one or more of the available service provider systems is not typically available to the reseller or to the station at that point in time.

### BRIEF DESCRIPTION OF THE DRAWINGS

Additional objects and advantages of the present invention will be more readily apparent from the following detailed description of preferred embodiments thereof when taken together with the accompanying drawings in which:

FIG. 1 is a diagram of components in an exemplary wireless communications system in which the method of reselling wireless services according to a preferred embodiment of the present invention is implemented;

FIG. 2 is a flow diagram of the method of reselling wireless services according to a preferred embodiment of the present invention; and

FIG. 3 is a flow diagram of a method of reselling wireless services according to another preferred embodiment of the present invention.

### DETAILED DESCRIPTION OF THE PREFERRED EMBODIMENTS

In overview form the present disclosure concerns wireless communications systems suitable for practicing a method of reselling or brokering or arranging for wireless services for subscriber devices or equipment coupled through such devices. Examples of such systems include various dispatch systems, cellular systems, personal communications systems, or future generation systems. As further discussed below various inventive principles and combinations thereof are advantageously employed to effect the brokering or arranging for services within the wireless communications system thus better meeting the needs or requirements of subscriber devices on an as required basis provided these principles or equivalents are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items, or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

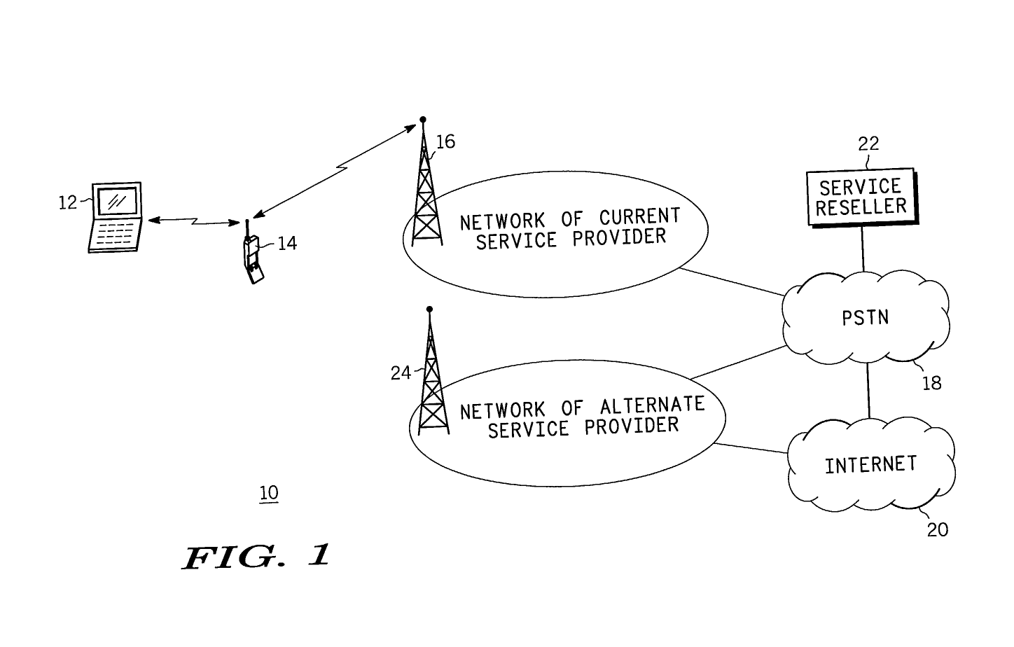

The present disclosure will discuss various embodiments in accordance with the invention. The system diagram of FIG. 1 will be used to lay the groundwork for a deeper understanding of the present invention and advantages thereof. FIG. 1 in large part and at the simplified level depicted is a representative diagram of a wireless communications system 10 and will serve to explain the problems and certain inventive solutions thereto according to the present invention.

Referring now to the drawings in which like reference numerals refer to like items, FIG. 1 shows the components of an exemplary wireless communications system 10 in which the method of reselling wireless services according to a preferred embodiment of the present invention is implemented. Specifically, terminal equipment such as, for example, a laptop computer, 12 (hereinafter referred to as TE) includes a connector or a cable (not shown) that enables the TE 12 to connect, via a wireless subscriber station such as a mobile or portable cellular phone 14 or other communications device (hereinafter referred to as MS), to a wireless network service provider system 16 (hereinafter referred to as SP). While in this case the MS 14 functions as a wireless modem for the TE 12, the TE 12 may alternatively be connected to the MS 14 via a known short-range wireless connection (not shown). The SP 16 in turn provides services to the MS 14 such as, for example, voice data or packet data transmission services, and enables the MS 14 to link the TE 12 to the publicly switched telephone network 18 and consequently to the Internet 20 in a manner known in the art.

The exemplary wireless communications system 10 also includes a service reseller 22 (hereinafter referred to as SR) in communication with the SP 16 as well as with one or more alternate SPs that are represented generally for discussion purposes as a single SP 24. As will be explained below in detail, the SR 22 has a dynamic relationship with the SPs 16, 24 both from a coverage standpoint and a services standpoint. Specifically, the MS 14 is programmed to search for SPs on certain frequencies. However, in accordance with the methodology of the present invention, the MS 14 is not limited to using a finite number of SPs programmed into its memory and is not limited to operating in a predetermined number of zones of operation. Rather, the SR 22 is capable of connecting the MS 14 to an SP, such as one of the SPs 16, 24, that is most advantageous to the MS 14 from a required services standpoint. As a result, the SR 22 is able to optimize its business because it can precisely control the SP selection of the MS 14 and therefore enable services to be provided to the MS 14 at a cost to the SR 22 that is typically lower than that achievable if the SR had a conventional static relationship with SPs from a services standpoint.

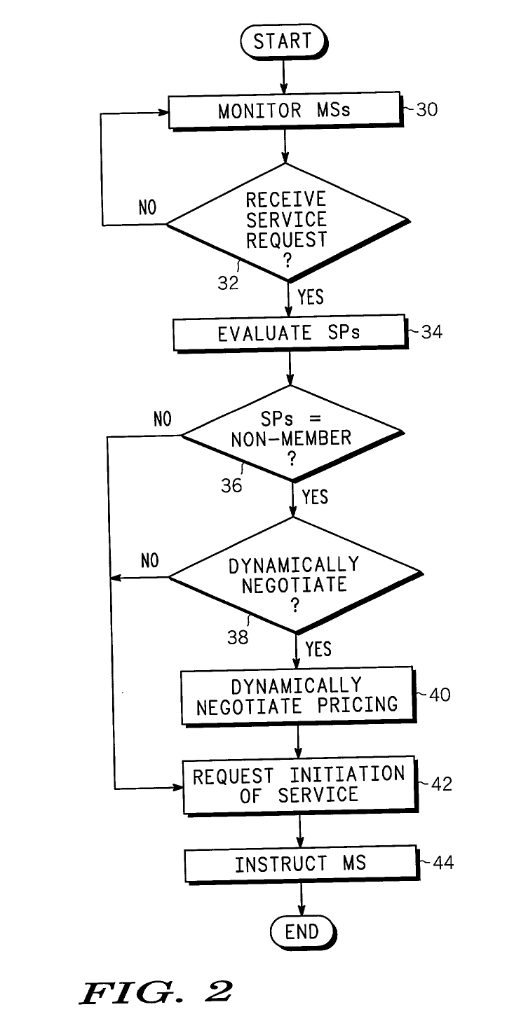

Referring now to FIG. 2, the methodology of the present invention will now be more specifically discussed. At 30, the SR 22 monitors transmissions of MSs such as the MS 14 for service requests. The MS 14 may transmit a service request when, for example, it initially enters a new zone of coverage and requires the services of an SP in the zone. However, as will be discussed below in detail, the MS 14 may also transmit a service request even when it is currently receiving services from an SP when its service requirements, such as bandwidth requirements, change from, for example, voice service via a wide area SP to large bandwidth data packet service via a local area SP, or from a voice-only conference service to a conference service that includes both voice and image multimedia. In addition, an association may be established between one or more available service provider systems, such as the SPs 16, 24, and the TE 12 so that the SR 22 can determine that the service request received from the MS 14 originates at the TE 12. Such an association can be established through, for example, an association database component stored at appropriate SPs, such as the SPs 16, 24.

At 32, if the SR 22 receives a service request from the MS 14, at 34 the SR 22 evaluates a plurality of available SPs, such as the SPs 16, 24, to determine which of the SPs is a most advantageous SP for the MS 14 based on the received service request. Specifically, the SR 22 queries, through conventional network communication links, databases related to services to the MS 14. The databases are, for example, HLRs, SP service agreement databases, and SR/SP agreement databases and contain information on services that MSs registered with particular SPs are authorized to use, as well as information on agreements between SPs such as the SPs 16, 24 that allow the MS 14 to utilize services of, for example, both SPs 16, 24 even if the MS 14 is owned by the SP 16. The databases also include agreements between the SR 22 and the SPs 16, 24 that allow the SR 22 to provide services via a specific SP, such as the SP 24, even if there is no agreement in place between the MS 14 and the SP 24. It should be appreciated that the SR 22 queries the databases of a plurality of potential SPs, including the SP 16, even if the SP 16 is currently providing services to the MS 12, to ensure that the most advantageous SP is chosen. Alternatively, the SR 22 may maintain its own available SP database that is dynamically updated and maintained in real-time, or it may obtain such a database service from a third-party vendor.

If the SR 22 determines as a result of its SP database queries that the SPs 16, 24 are capable of providing the services requested by the MS 14, then at 36 the SR 22 determines whether the SPs 16, 24 are non-member SPs, i.e., whether the SPs 16, 24 have a service reseller agreement in place with the SR 22. If such agreements are not in place, then at 38 the SR 22 determines whether it can dynamically negotiate a service agreement with nonmember SPs. If the SR 22 determines that it can dynamically negotiate with non-member SPs such as, for example, the SP 24, based on, for example, dynamic pricing features programmed into the SP 24, at 40 the SR 22 dynamically negotiates pricing with the SP 24 to enable the MS 14 to receive services from the SP 24 if the SP 24 is determined to be a most advantageous SP that is available, but not necessarily readily accessible, due to its non-membership status with the SR 22. Subsequently, at 42 the SR 22 requests initiation of a service or services at the most advantageous SP.

At 38, the SR 22 may determine that it need not dynamically negotiate with nonmember SPs such as the SP 24 because, for example, the SP 24 may be programmed with predetermined set pricing for providing services on an as-needed basis when the SP 24 receives service requests from SRs that do not have a service reseller agreement in place with the SP 24. In such a situation, at 42 the SR 22 requests initiation of service with the most advantageous SP without having to dynamically negotiate pricing with the SP 24.

When the SR 22 at 42 requests initiation of service with the most advantageous SP, it may, for example, insert information about the MS 14 into a database of the available but not accessible most advantageous SP so that the available but not accessible most advantageous SP becomes accessible to the MS 14. Such MS information may be used to initiate service with the available but not accessible most advantageous SP on a temporary basis and may limit the SP to providing the service or services to the MS 14 for a time period having a predetermined maximum duration of validity. In addition, the SR 22 may also insert reseller identification information on a channel of the available but not accessible most advantageous SP so that the available but not accessible most advantageous SP becomes accessible to the MS 14. The validity of such reseller identification information may also be limited to a maximum duration of validity.

Alternatively, the SR 22 may program information about the available but not accessible most advantageous SP such as, for example, service provider identification information, service provider protocol information and/or service provider channel frequency information, into the MS 14 so that the available but not accessible most advantageous SP becomes accessible to the MS 14. The SR 22 can then remove the information based on predetermined service completion parameters if the SP requires that such information be removed upon termination of the service or services. The information can be removed based on, for example, duration information pre-programmed into the MS. The SR 22 may also require that the SP limit an amount of data transmitted to and/or from the MS 14 to a predetermined maximum amount, or that the SP tear down its connection with the MS 14 based upon predetermined service completion parameters.

Once the SR 22 at 42 requests and receives initiation of service with the most advantageous SP, at 44 the SR 22 subsequently instructs the MS 14 to initiate communication using the most advantageous SP as determined based on the evaluation of available service provider systems at 34 and, if certain SPs are non-member SPs, the processing performed at 36-42 as discussed above, to determine a most advantageous SP for the MS 14. In addition to information gleaned from SP databases, the SR 22 may also, or alternatively, utilize information that may be included in the service request received from the MS 14 and related to MS service requirements. Information in the received service request may include data on load requirements, bandwidth, channel quality, coverage, and/or pricing parameters of the MS 14 and/or the most advantageous SP. It also may include information on the current zone or geographical location of the MS 14 and/or information on received SP and zone identifications detected by the MS 14, including indications that are not in the MS's lists of SPs and zones. The information may be used by the SR 22 in the selection of the most advantageous SP for the MS 14. If the SR 22 must dynamically negotiate with one or more SPs to determine a most advantageous SP, the SR 22 may also use such dynamic negotiation information in determining a most advantageous SP.

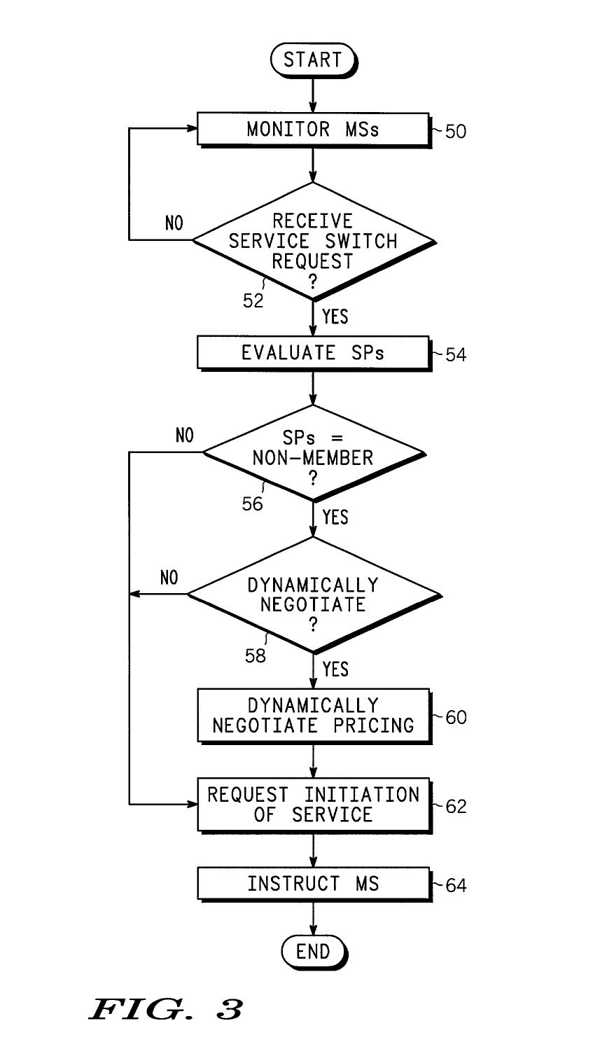

Referring now to FIG. 3, the methodology of the present invention will be described as specifically applied when the SR 22 receives a service request that is a service switch request from the MS 14. Specifically, at 50 the SR 22 monitors all MSs, such as the MS 14, within a particular zone of coverage of the SR 22 even after the MS 14 initiates communication using an SP, such as the SP 16, that at the time is determined to be the most advantageous SP. At 52, when the SR 22 receives a service switch request from the MS 14 that indicates that the MS 14 requires a service or services that are substantially different from the services currently being provided by the current SP 16, at 54 the SR 22 locates and evaluates SPs, such as the SP 24, that are capable of providing the service or services required by the MS 14 and that are available but not necessarily accessible to the MS 14. The service switch request may also be triggered by channel deterioration when a current channel can no longer reliably or efficiently deliver the required service or services. Subsequently, as with the earlier discussed methodology, at 56 and 58 the SR 22 determines whether the SP 24 is a non-member SP and, if so, whether it should dynamically negotiate a service agreement with the non-member SP 24. At 60, the SR 22 dynamically negotiates a service agreement with the non-member SP 24 in a manner similar to the earlier discussed methodology at 40 in FIG. 2, and at 62 the SR 22 requests, and receives, initiation of the service or services at the SP 24. At 64, the SR 22 instructs the MS 14 to initiate communication with the SP 24, if the SP 24 is determined to be the most advantageous SP with respect to the MS 14, in a manner similar to that discussed at 44 in FIG. 2.

As a result an MS need not obtain required services from an SP it would otherwise first select as a result of a conventionally-programmed SR when it registers in a new zone, as the MS can obtain a service or services through the SR that are more germane to the instantaneous service requirements of the MS even if a most advantageous SP is available to but not immediately accessible by the SR. In addition, an MS need not continue to receive required services from a current SP, as it can request, and obtain, a service switch to another SP in response to changing service requirements even if the switched-to SP is available to, but not accessible by, the SR at the time of the service switch request.

It should be appreciated that the method of reselling wireless services of the present invention may be modified according to specific system parameters and according to the specific processing capabilities of system components. For example, while the processing for determining the most advantageous SP has been described as being performed at the SR 22, some or all of the processing could alternatively be performed at the individual SPs being queried by the SR, or at the MS. In addition, the MS 14 may be programmed via the SR 22 to enable user-driven selection of a most advantageous SP. Specifically, an MS 14 could be programmed to display a list of potential services such as voice, SMS, and/or low/high bandwidth data services. A user could then select a desired service for the MS based on the anticipated application to be run at the TE, and the SR could then perform its SP query as discussed above in connection with FIGS. 2 and 3 to determine a most advantageous SP with regard to the requested service.

Additionally, it is also contemplated that the method of reselling wireless services of the present invention may be modified to accommodate an association between the TE and the SR, rather than between the MS and the SR as discussed above. In this case, the TE would contact the SR via the MS after the MS has registered, and the TE would send service requests and service switch requests to the SR. In this case, the SR would still move the MS to another SP, if appropriate. Such a configuration would allow a user of the TE to connect via any subscriber station.

While the above description is of the preferred embodiment of the present invention, it should be appreciated that the invention may be modified, altered, or varied without deviating from the scope and fair meaning of the following claims.

What is claimed is:

1. A method of connecting a subscriber station to an available service provider system, comprising:
receiving a service request from the subscriber station;
evaluating available service provider systems to determine a most advantageous service provider system for the subscriber station based on the received service request; and
instructing the subscriber station to initiate communication using the most advantageous service provider system as determined based on the evaluation of available service provider systems to determine a most advantageous service provider system for the subscriber station based on the received service request.

2. The method of claim 1, wherein the evaluating of available service provider systems to determine a most advantageous service provider system for the subscriber station based on the received service request includes evaluating a service provider system that is servicing the subscriber station.

3. The method of claim 1, further comprising receiving from the subscriber station current service provider information identifying a service provider system that is servicing the subscriber station prior to the evaluating of available service provider systems to determine a most advantageous service provider system for the subscriber station based on the received service request.

4. The method of claim 1, further comprising, after the evaluating of available service provider systems to determine a most advantageous service provider system for the subscriber station based on the received service request, requesting initiation of service on the most advantageous service provider system for the subscriber station even if the most advantageous service provider system is available but not accessible to the subscriber station.

5. The method of claim 4, wherein the requesting of initiation of service with the available but not accessible most advantageous service provider system comprises inserting information about the subscriber station into a database of the available but not accessible most advantageous service provider system so that the available but not accessible most advantageous service provider system becomes accessible to the subscriber station.

6. The method of clam 5, wherein the inserting of information about the subscriber station into a database of the available but not accessible most advantageous service provider system so that the available but not accessible most advantageous service provider system becomes accessible to the subscriber station comprises inserting the information about the subscriber station into the database of the available but not accessible most advantageous service provider system to initiate service with the available but not accessible most advantageous service provider system on a temporary basis.

7. The method of claim 6, wherein the inserting of the information about the subscriber station into the database of the available but not accessible most advantageous service provider system to provide initiation of service with the available but not accessible most advantageous service provider system on a temporary basis comprises inserting the information about the subscriber station into a database of the available but not accessible most advantageous service provider system for a time period having a predetermined maximum duration of validity.

8. The method of claim 4, wherein the requesting of initiation of service on the most advantageous service provider system for the subscriber station even if the most advantageous service provider system is available but not accessible to the subscriber station further comprises inserting reseller identification information on a channel of the available but not accessible most advantageous service provider system so that the available but not accessible most advantageous service provider system becomes accessible to the subscriber station.

9. The method of claim 8, wherein the inserting of reseller identification information on a channel of the available but not accessible most advantageous service provider system so that the available but not accessible most advantageous service provider system becomes accessible to the subscriber station further comprises limiting validity of the reseller identification information to a predetermined maximum period of time.

10. The method of claim 4, wherein the specifying initiation of service with the available but not accessible most advantageous service provider system based on specified temporary service parameters comprises programming information about the available but not accessible most advantageous service provider system into the subscriber station so that the available but not accessible most advantageous service provider system becomes accessible to the subscriber station.

11. The method of claim 10, wherein the programming of information about the available but not accessible most advantageous service provider system into the subscriber station so that the available but not accessible most advantageous service provider system becomes accessible to the subscriber station comprises programming at least one of service provider identification information, service provider protocol information and service provider channel frequency information into the subscriber station.

12. The method of claim 11, further comprising removing the information about the available but not accessible most advantageous service provider system programmed into the subscriber station based on predetermined service completion parameters.

13. The method of claim 4, further comprising, after the requesting of initiation of service on the most advantageous service provider system for the subscriber station even if the most advantageous service provider system is available but not accessible to the subscriber station, limiting data transmitted to and from the subscriber station to a predetermined maximum amount.

14. The method of claim 4, further comprising, after the requesting of initiation of service on the most advantageous service provider system for the subscriber station even if the most advantageous service provider system is available but not accessible to the subscriber station, communicating with the most advantageous service provider system to request that the most advantageous service provider system tear down its connection with the subscriber station based upon predetermined service completion parameters.

15. The method of claim 1, wherein the instructing of the subscriber station to initiate communication using the most advantageous service provider system as determined based on the evaluating of available service provider systems to determine a most advantageous service provider system for the subscriber station based on the received service request comprises instructing the subscriber station at least in part based on one or more of present load, bandwidth, channel quality, coverage, and pricing requirements of at least one of the subscriber station and the available service provider systems.

16. The method of claim 1, further comprising, after the evaluating of available service provider systems to determine a most advantageous service provider system for the subscriber station based on the received service request, dynamically negotiating with the available service provider systems for service prices; and
the instructing of the subscriber station to initiate communication using the most advantageous service provider system as determined based on the evaluating of available service provider systems to determine a most advantageous service provider system for the subscriber station based on the received service request is based at least in part on results from the dynamically negotiating with the available service provider systems for service prices.

17. The method of claim 1, further comprising establishing an association between one or more of the available service provider systems and a terminal equipment connected to the subscriber station, and determining that the service request received from the subscriber station originates at the terminal equipment.

18. The method of claim 1, where the receiving of a service request from the subscriber station comprises receiving a service switch request from the subscriber station.

19. A method of dynamically adding service provider systems to a service reseller network, comprising:
detecting a need for a service required by a subscriber station;
determining that the service required by the subscriber station cannot be advantageously provided by a current service provider system;
locating service provider systems capable of providing the service required by the subscriber station and that are available but not necessarily accessible to the subscriber station; and
providing the subscriber station with access to a most advantageous service provider system chosen from the located service provider systems capable of providing the service required by the subscriber station and that are available but not necessarily accessible to the subscriber station.

20. The method of claim 19, wherein the providing of the subscriber station with access to a most advantageous service provider system chosen from the located service provider systems capable of providing the service required by the subscriber station and that are available but not necessarily accessible to the subscriber station comprises providing the subscriber station with access to the most advantageous service provider system for only a predetermined period of time.

21. The method of claim 19, further comprising, after the locating of service provider systems capable of providing the service required by the subscriber station and that are available but not necessarily accessible to the subscriber station, dynamically negotiating service prices with the service provider systems capable of providing the service required by the subscriber station and that are available but not accessible to the subscriber station to facilitate identifying the most advantageous service provider system.

22. The method of claim 19, further comprising, after the locating of service provider systems capable of providing the service required by the subscriber station and that are available but not necessarily accessible to the subscriber station, instructing the subscriber station at least in part based on one or more of present load parameters, bandwidth, channel quality, coverage, and pricing requirements of at least one of the subscriber station and the service provider systems capable of providing the service required by the subscriber station and that are available but not necessarily accessible to the subscriber station; and
prior to the providing of the subscriber station with access to a most advantageous service provider system chosen from the located service provider systems capable of providing the service required by the subscriber station and that are available but not necessarily accessible to the subscriber station, identifying the most advantageous service provider system based at least in part on results of the instructing the subscriber station at least in part based on one or more of present load parameters, bandwidth, channel quality, coverage, and pricing requirements of at least one of the subscriber station and the service provider systems capable of providing the service required by the subscriber station and that are available but not necessarily accessible to the subscriber station.

23. The method of claim 19, further comprising establishing an association between one or more of the available service provider systems and a terminal equipment connected to the subscriber station, and determining that the service request received from the subscriber station originates at the terminal equipment.

24. The method of claim 19, where the detecting of a need for a service required by a subscriber station comprises detecting a need for a service switch request required by the subscriber station.
